(19) United States
(12) Patent Application Publication
(10) Pub. No.: US 2022/0051079 A1
(43) Pub. Date: Feb. 17, 2022

(54) AUTO-ENCODING USING NEURAL NETWORK ARCHITECTURES BASED ON SYNAPTIC CONNECTIVITY GRAPHS

(71) Applicant: X Development LLC, Mountain View, CA (US)

(72) Inventor: Sarah Ann Laszlo, Mountain View, CA (US)

(21) Appl. No.: 16/994,487

(22) Filed: Aug. 14, 2020

(51) Int. Cl. G06N 3/04; G06N 5/02; G06K 9/62; G06T 7/00

(52) U.S. Cl. CPC G06N 3/0427; G06N 5/02; G06T 7/0012; G06K 9/6264; G06K 9/6257

(57) ABSTRACT

Methods, systems, and apparatus, including computer programs encoded on a computer storage medium, for selecting a neural network architecture for performing a prediction task for data elements of a specified data type. In one aspect, a method comprises: obtaining data defining a synaptic connectivity graph representing synaptic connectivity between neurons in a brain of a biological organism; generating a plurality of candidate graphs based on the synaptic connectivity graph; for each candidate graph of the plurality of candidate graphs: determining an auto-encoding neural network architecture based on the candidate graph; training an auto-encoding neural network having the auto-encoding neural network architecture to perform an auto-encoding task for data elements of the specified data type; and determining a performance measure characterizing a performance of the auto-encoding neural network in performing the auto-encoding task; and selecting the neural network architecture based on the performance measures.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes an architecture selection system implemented as computer programs on one or more computers in one or more locations. The architecture selection system can identify an artificial neural network architecture that is predicted to be effective for performing a particular class of machine learning tasks, in particular, machine learning tasks that involve processing inputs of a specified data type to generate predictions.

The specified data type of the inputs may be, e.g., image data, video data, audio data, textual data, point cloud data (e.g., as generated by a lidar or radar sensor), or any other appropriate data type. In some cases, the specified data type of the inputs may be narrower, e.g., satellite images, magnetic resonance images (Mills), or hyperspectral images, rather than images generally. In some cases, the specified data type of the inputs may be a combination of multiple data types, e.g., a combination of video data and audio data.

The architecture selection system identifies a neural network architecture that is predicted to be effective for processing inputs of the specified data type to perform a range of possible prediction tasks, rather than being specific to a particular prediction task. The possible prediction tasks may include, e.g., classification tasks, regression tasks, segmentation tasks, or any other appropriate prediction task. A neural network architecture may be referred to as being “effective” for a prediction task, e.g., if a neural network having the neural network architecture can be trained to perform the prediction task with an acceptable accuracy

The architecture selection system identifies a neural network architecture that is predicted to be effective for processing inputs of the specified data type to generate predictions by searching a space of possible neural network architectures. The architecture selection system seeds (i.e., initializes) the search through the space of possible neural network architectures using a synaptic connectivity graph representing synaptic connectivity in the brain of a biological organism. In particular, the architecture selection system uses the synaptic connectivity graph to derive a set of “candidate” graphs, each of which can be mapped to a corresponding auto-encoding neural network architecture for performing an auto-encoding task for inputs of the specified data type. The architecture selection system then selects a neural network architecture for performing prediction tasks for inputs of the specified data type based on the best-performing neural network architectures for the auto-encoding task, as will be described in more detail below.

As used throughout this specification, a “neural network” refers to an artificial neural network, i.e., that is implemented by one or more computers.

According to a first aspect there is provided a method performed by one or more data processing apparatus, the method comprising: obtaining data defining a synaptic connectivity graph representing synaptic connectivity between neurons in a brain of a biological organism; generating a plurality of candidate graphs based on the synaptic connectivity graph; for each candidate graph of the plurality of candidate graphs: determining an auto-encoding neural network architecture based on the candidate graph; training an auto-encoding neural network having the auto-encoding neural network architecture to perform an auto-encoding task for data elements of a specified data type, comprising, at each of a plurality of training iterations: processing an input data element of the specified data type using the auto-encoding neural network to generate a reconstruction of the input data element; and adjusting current parameter values of the auto-encoding neural network to reduce an error between: (i) the input data element, and (ii) the reconstruction of the input data element; and determining a performance measure characterizing a performance of the auto-encoding neural network in performing the auto-encoding task for data elements of the specified data type; and selecting a neural network architecture for performing a prediction task for data elements of the specified data type based on the performance measures, wherein the prediction task comprises processing a data element of the specified data type to generate a corresponding prediction output.

In some implementations, the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

In some implementations, obtaining data defining the synaptic connectivity graph representing synaptic connectivity between neurons in the brain of the biological organism comprises: obtaining a synaptic resolution image of at least a portion of the brain of the biological organism; and processing the image to identify: (i) a plurality of neurons in the brain, and (ii) a plurality of synaptic connections between pairs of neurons in the brain.

In some implementations, the synaptic resolution image of the brain of the biological organism is generated using electron microscopy.

In some implementations, identifying the plurality of candidate graphs based on the synaptic connectivity graph comprises, at each of a plurality of iterations: processing the synaptic connectivity graph in accordance with current values of a set of graph generation parameters to generate a current candidate graph; and updating the current values of the set of graph generation parameters based on the performance measure characterizing the performance of the auto-encoding neural network having the auto-encoding neural network architecture corresponding to the current candidate graph in performing the auto-encoding task for data elements of the given type.

In some implementations, the current values of the set of graph generation parameters are updated using an optimization technique.

In some implementations, the optimization technique is a black-box optimization technique.

In some implementations, the specified data type comprises an image data type, an audio data type, or a textual data type.

In some implementations, for each candidate graph of the plurality of candidate graphs, the auto-encoding neural network architecture based on the candidate graph comprises a brain emulation sub-network having an architecture that is specified by the candidate graph, wherein: for each node in the candidate graph, the brain emulation sub-network architecture includes a respective artificial neuron corresponding to the node; and for each edge in the candidate graph, the brain emulation sub-network architecture includes a connection between a pair of artificial neurons that correspond to a pair of nodes in the candidate graph that are connected by the edge.

In some implementations, the auto-encoding neural network architecture based on the candidate graph further comprises an input sub-network and an output sub-network, wherein processing the input data element of the specified data type using the auto-encoding neural network having the auto-encoding neural network architecture comprises: processing the input data element by the input sub-network to generate an embedding of the input data element; processing the embedding of the input data element by the brain emulation sub-network to generate an alternative representation of the input data element; and processing the alternative representation of the input data element by the output sub-network to generate the reconstruction of the input data element.

In some implementations, adjusting the current parameter values of the auto-encoding neural network comprises: adjusting only current parameter values of the input sub-network and the output sub-network, wherein parameter values of the brain emulation sub-network are not adjusted during the training.

In some implementations, the parameter values of the brain emulation sub-network are determined prior to the training based on weight values associated with synaptic connections between neurons in the brain of the biological organism.

In some implementations, determining the performance measure characterizing the performance of the auto-encoding neural network in performing the auto-encoding task for data elements of the specified data type comprises, after the training of the auto-encoding neural network: processing each of one or more validation data elements of the specified data type using the auto-encoding neural network to generate a respective reconstruction of each validation data element; and determining the performance measure based on, for each validation data element, an error between: (i) the validation data element, and (ii) the reconstruction of the validation data element.

In some implementations, the auto-encoding neural network is trained for a predefined number of training iterations.

In some implementations, the prediction task is different than the auto-encoding task.

In some implementations, the prediction task comprises processing a data element of the specified data type to generate a classification of the data element into a plurality of classes.

In some implementations, selecting the neural network architecture for performing the prediction task for data elements of the specified type based on the performance measures comprises: selecting a candidate graph of the plurality of candidate graphs based on the performance measures; and determining a prediction neural network architecture based on the candidate graph.

According to another aspect, there is provided a system comprising: one or more computers; and one or more storage devices communicatively coupled to the one or more computers, wherein the one or more storage devices store instructions that, when executed by the one or more computers, cause the one or more computers to perform the operations of the methods described herein.

According to another aspect, there are provided one or more non-transitory computer storage media storing instructions that when executed by one or more computers cause the one or more computers to perform the operations of the methods described herein.

Particular embodiments of the subject matter described in this specification can be implemented so as to realize one or more of the following advantages.

The architecture selection system can identify a neural network architecture that is predicted to be effective for processing inputs of a specified data type by searching a space of possible architectures that are derived from a synaptic connectivity graph representing synaptic connectivity in the brain of a biological organism. The brain of the biological organism may be adapted by evolutionary pressures to be effective at solving certain tasks. For example, in contrast to many conventional computer vision techniques, a biological brain may process visual data to generate a robust representation of the visual data that may be insensitive to factors such as the orientation and size of elements (e.g., objects) characterized by the visual data. By seeding the neural architecture search process using the synaptic connectivity graph, the architecture selection system may facilitate the discovery of biologically-inspired neural network architectures that inherit the capacity of the biological brain to effectively solve tasks.

The architecture selection system identifies a neural network architecture that is predicted to be effective for processing inputs of a specified data type to perform a range of possible prediction tasks, rather than being specific to a particular prediction task. To this end, the architecture selection system searches for a neural network architecture that can effectively perform an auto-encoding task for inputs of the specified data type, rather than directly searching for a neural network architecture that can effectively perform a particular prediction task. To effectively perform an auto-encoding task for inputs of the specified data type, a neural network architecture must have the capacity to generate informative internal representations of inputs of the specified data type. Therefore, the performance of a neural network architecture on an auto-encoding task for inputs of the specified data type may be predictive of the performance of the neural network architecture for prediction tasks that involve processing inputs of the specified data type. The architecture selection system can thus reduce consumption of computational resources (e.g., memory and computing power) by obviating the requirement to perform a different neural architecture search for each possible prediction task, and rather, identify a neural network architecture that may be effective for performing many prediction tasks.

To perform the neural architecture search, the architecture selection system evaluates the performance of multiple neural network architectures derived from the synaptic connectivity graph on an auto-encoding task for inputs of the specified data type. The architecture selection system evaluates the performance of a neural network architecture on the auto-encoding task by training a neural network having the neural network architecture to perform the auto-encoding task. The architecture selection system can rapidly train the neural network to perform the auto-encoding task, e.g., by training only a fraction of the total parameters of the neural network, and by performing only a limited number of training iterations, e.g., tens or hundreds of training iterations. In contrast, some conventional systems may train the neural network by training every parameter of the neural network over a large number of training iterations, e.g., hundreds of thousands or millions of training iterations. Therefore, the architecture selection system described in this specification may consume fewer computational resources (e.g., memory and computing power) than conventional systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data flow for generating a synaptic connectivity graph representing synaptic connectivity between neurons in the brain of a biological organism.

FIG. 2 shows an example architecture selection system.

FIG. 3 shows an example of an auto-encoding neural network architecture that may be generated by the architecture selection system by processing a candidate graph derived from a synaptic connectivity graph.

FIG. 4 shows an example of a prediction neural network architecture that may be generated by the architecture selection system by processing a candidate graph derived from a synaptic connectivity graph.

FIG. 5 is a flow diagram of an example process for selecting a neural network architecture for performing a prediction task for data elements of a specified data type.

FIG. 6 is a block diagram of an example computer system.

Like reference numbers and designations in the various drawings indicate like elements.

### DETAILED DESCRIPTION

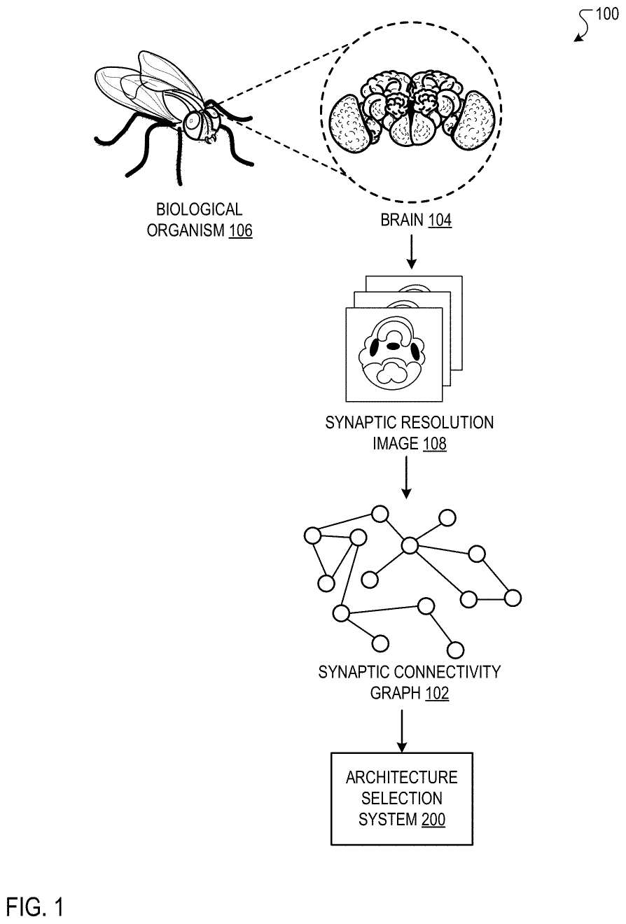

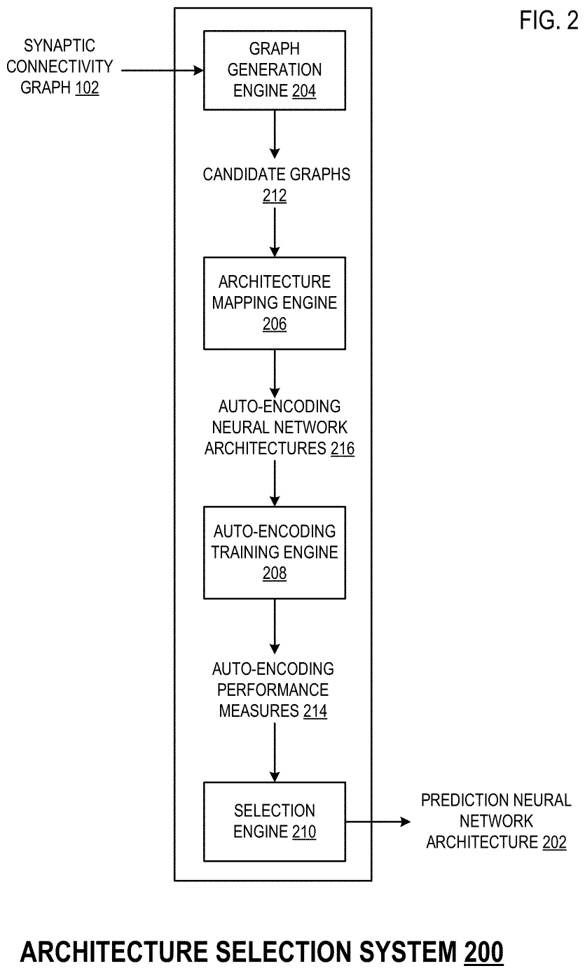

FIG. 1 shows an example data flow 100 for generating a synaptic connectivity graph 102 representing synaptic connectivity between neurons in the brain 104 of a biological organism 106, where the synaptic connectivity graph 102 is subsequently provided to an architecture selection system 200. The architecture selection system 200 is described in more detail with reference to FIG. 2. As used throughout this document, a brain may refer to any amount of nervous tissue from a nervous system of a biological organism, and nervous tissue may refer to any tissue that includes neurons (i.e., nerve cells). The biological organism 106 may be, e.g., a worm, a fly, a mouse, a cat, or a human.

An imaging system may be used to generate a synaptic resolution image 108 of the brain 104. An image of the brain 104 may be referred to as having synaptic resolution if it has a spatial resolution that is sufficiently high to enable the identification of at least some synapses in the brain 104. Put another way, an image of the brain 104 may be referred to as having synaptic resolution if it depicts the brain 104 at a magnification level that is sufficiently high to enable the identification of at least some synapses in the brain 104. The image 108 may be a volumetric image, i.e., that characterizes a three-dimensional representation of the brain 104. The image 108 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 104 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 108 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 108 to generate the synaptic connectivity graph 102. The synaptic connectivity graph 102 specifies a set of nodes and a set of edges, such that each edge connects two nodes. To generate the graph 102, the graphing system identifies each neuron in the image 108 as a respective node in the graph, and identifies each synaptic connection between a pair of neurons in the image 108 as an edge between the corresponding pair of nodes in the graph.

The graphing system may identify the neurons and the synapses depicted in the image 108 using any of a variety of techniques. For example, the graphing system may process the image 108 to identify the positions of the neurons depicted in the image 108, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 108 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 108 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 102. For example, the graphing system may identify a weight for an edge connecting two nodes in the graph 102 based on the area of overlap between the tolerance regions around the respective neurons corresponding to the nodes in the image 108. The area of overlap may be measured, e.g., as the number of voxels in the image 108 that are contained in the overlap of the respective tolerance regions around the neurons. The weight for an edge connecting two nodes in the graph 102 may be understood as characterizing the (approximate) strength of the connection between the corresponding neurons in the brain (e.g., the amount of information flow through the synapse connecting the two neurons).

In addition to identifying synapses in the image 108, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 108, the graphing system may associate each edge in the graph 102 with direction of the corresponding synapse. That is, the graph 102 may be a directed graph. In other implementations, the graph 102 may be an undirected graph, i.e., where the edges in the graph are not associated with a direction.

The graph 102 may be represented in any of a variety of ways. For example, the graph 102 may be represented as a two-dimensional array of numerical values, referred to as an “adjacency matrix”, with a number of rows and columns equal to the number of nodes in the graph. The component of the array at position (i,j) may have value 1 if the graph includes an edge pointing from node i to node j, and value 0 otherwise. In implementations where the graphing system determines a weight value for each edge in the graph 102, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

The synaptic connectivity graph 102 may be processed by the architecture selection system 200, which will be described in more detail next.

FIG. 2 shows an example architecture selection system 200. The architecture selection system 200 is an example of a system implemented as computer programs on one or more computers in one or more locations in which the systems, components, and techniques described below are implemented.

The system 200 is configured to search a space of possible neural network architectures to identify a “prediction” neural network architecture 202 for processing inputs of a specified data type to generate prediction outputs. The system 200 seeds the search through the space of possible neural network architectures using a synaptic connectivity graph 102 representing synaptic connectivity in the brain of a biological organism. The synaptic connectivity graph 102 may be derived directly from a synaptic resolution image of the brain of a biological organism, e.g., as described with reference to FIG. 1. In some cases, the synaptic connectivity graph 102 may be a sub-graph of a larger graph derived from a synaptic resolution image of a brain, e.g., a sub-graph that includes neurons of a particular type, e.g., visual neurons, olfactory neurons, or memory neurons.

The system 200 includes a graph generation engine 204, an architecture mapping engine 206, an auto-encoding training engine 208, and a selection engine 210, each of which will be described in more detail next.

The graph generation engine 204 is configured to process the synaptic connectivity graph 102 to generate multiple “candidate” graphs 212, where each candidate graph is defined by a set of nodes and a set of edges, such that each edge connects a pair of nodes. The graph generation engine 204 may generate the candidate graphs 212 from the synaptic connectivity graph 102 using any of a variety of techniques. A few examples follow.

In one example, the graph generation engine 204 may generate a candidate graph 212 at each of multiple iterations by processing the synaptic connectivity graph 102 in accordance with current values of a set of graph generation parameters. The current values of the graph generation parameters may specify operations to be applied to an adjacency matrix representing the synaptic connectivity graph 102 to generate an adjacency matrix representing a candidate graph 212. The operations to be applied to the adjacency matrix representing the synaptic connectivity graph may include, e.g., filtering operations, cropping operations, or both. The candidate graph 212 may be defined by the result of applying the operations specified by the current values of the graph generation parameters to the adjacency matrix representing the synaptic connectivity graph 102.

The graph generation engine 204 may apply a filtering operation to the adjacency matrix representing the synaptic connectivity graph 102, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 102 may have the effect of adding edges to the synaptic connectivity graph 102, removing edges from the synaptic connectivity graph 102, or both.

The graph generation engine 204 may apply a cropping operation to the adjacency matrix representing the synaptic connectivity graph 102, where the cropping operation replaces the adjacency matrix representing the synaptic connectivity graph 102 with an adjacency matrix representing a sub-graph of the synaptic connectivity graph 102. The cropping operation may specify a sub-graph of synaptic connectivity graph 102, e.g., by specifying a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

At each iteration, the system 200 determines an auto-encoding performance measure 214 corresponding to the candidate graph 212 generated at the iteration, and the system 200 updates the current values of the graph generation parameters to encourage the generation of candidate graphs 212 with higher auto-encoding performance measures 214. The auto-encoding performance measure 214 for a candidate graph 212 characterizes the performance of a neural network architecture specified by the candidate graph 212 at processing inputs of the specified data type to perform an auto-encoding task, as will be described in more detail below. The system 200 may use any appropriate optimization technique to update the current values of the graph generation parameters, e.g., a “black-box” optimization technique that does not rely on computing gradients of the operations performed by the graph generation engine 204. Examples of black-box optimization techniques which may be implemented by the optimization engine 846 are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 204 may generate the candidate graphs 212 by “evolving” a population (i.e., a set) of graphs derived from the synaptic connectivity graph 102 over multiple iterations. The graph generation system 200 may initialize the population of graphs, e.g., by “mutating” multiple copies of the synaptic connectivity graph 102. Mutating a graph refers to making a random change to the graph, e.g., by randomly adding or removing edges or nodes from the graph. After initializing the population of graphs, the graph generation system 200 may generate a candidate graph at each of multiple iterations by, at each iteration, selecting a graph from the population of graphs derived from the synaptic connectivity graph and mutating the selected graph to generate a candidate graph 212. The graph generation engine 204 may determine an auto-encoding performance measure 214 for the candidate graph 212, and use the auto-encoding performance to determine whether the candidate graph 212 is added to the current population of graphs.

In some implementations, each edge of the synaptic connectivity graph may be associated with a weight value that is determined from the synaptic resolution image of the brain, as described above. Each candidate graph may inherit the weight values associated with the edges of the synaptic connectivity graph. For example, each edge in the candidate graph that corresponds to an edge in the synaptic connectivity graph may be associated with the same weight value as the corresponding edge in the synaptic connectivity graph. Edges in the candidate graph that do not correspond to edges in the synaptic connectivity graph may be associated with default or randomly initialized weight values.

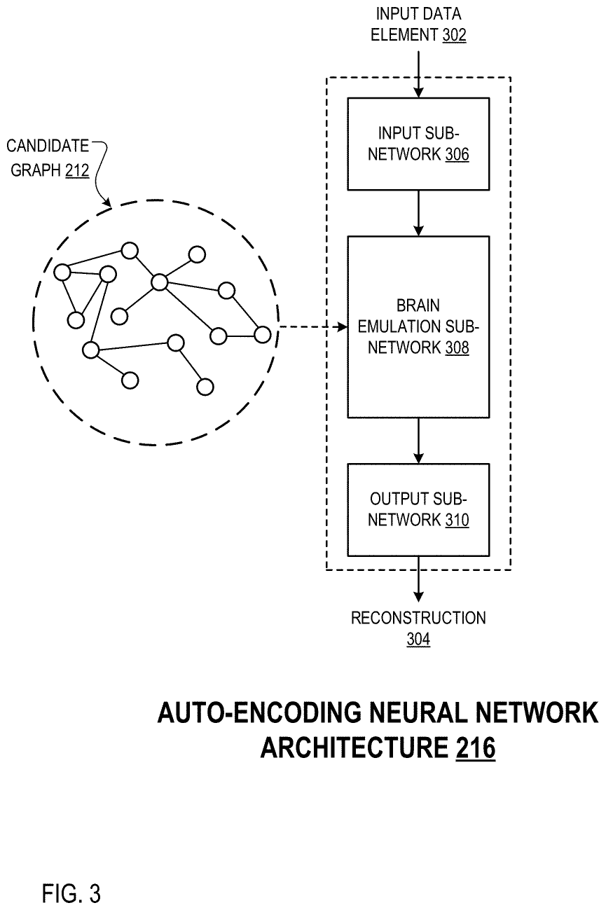

The architecture mapping engine 206 processes each candidate graph 212 to generate a corresponding auto-encoding neural network architecture 216 that is configured to perform an auto-encoding task for inputs of the specified data type. That is, each auto-encoding neural network architecture 216 is configured to process an input of the specified data type to generate an output that is an (approximate or exact) reconstruction of the input. The architecture mapping engine 206 may generate an auto-encoding neural network architecture 216 from a candidate graph 212 in a variety of ways. For example, the architecture mapping engine 206 may map each node in the candidate graph 212 to a corresponding artificial neuron and each edge in the candidate graph 212 to a connection between a corresponding pair of artificial neurons in auto-encoding neural network architecture 216. Generating an auto-encoding neural network architecture from a candidate graph is described in more detail with reference to FIG. 3.

For each auto-encoding neural network architecture 216, the auto-encoding training engine 208: (i) trains a neural network having the auto-encoding neural network architecture to perform an auto-encoding task for data elements of the specified data type, and (ii) determines an auto-encoding performance measure 214 of the neural network.

The training engine 208 trains the auto-encoding neural network having the auto-encoding neural network architecture over multiple training iterations. At each training iteration, the training engine 208 samples a current “batch” (i.e., set) of data elements of the specified data type, and processes each data element in the current batch using the auto-encoding neural network to generate an output that defines a “reconstruction” (i.e., estimate) of the input data element. The training engine 208 then adjusts the current parameter values of the auto-encoding neural network to reduce an error (e.g., a squared-error) between: (i) the data element, and (ii) the reconstruction of the data element, for each data element in the current batch.

The training engine 208 may adjust the current parameter values of the auto-encoding neural network by determining gradients of the error with respect to the parameter values of the auto-encoding neural network (e.g., using backpropagation), and using the gradients to adjust the current parameter values of the auto-encoding neural network. The training engine 208 may use the gradients to adjust the current parameter values of the auto-encoding neural network using any appropriate gradient descent optimization procedure, e.g., RMSprop or Adam. Rather than training every parameter of the auto-encoding neural network, the training engine 208 may train only a fraction of the total number of parameters of the auto-encoding neural network, as will be described in more detail with reference to FIG. 3. The training engine 208 may determine that training is complete, e.g., after a predetermined number of training iterations have been performed.

The training engine 208 determines the auto-encoding performance measure 214 for the auto-encoding neural network based on the performance of the auto-encoding neural network on the auto-encoding task. For example, to determine the auto-encoding performance measure, the training engine 208 may obtain a “validation” set of data elements that were not used during training of the auto-encoding neural network, and process each of these data elements using the trained auto-encoding neural network to generate a corresponding reconstruction. The training engine 208 may then determine the auto-encoding performance measure 214 based on the respective error (e.g., squared-error) between: (i) the data element, and (ii) the reconstruction of the data element, for each data element in the validation set. For example, the training engine 208 may determine the auto-encoding performance measure 214 as the average error or the maximum error over the data elements of the validation set.

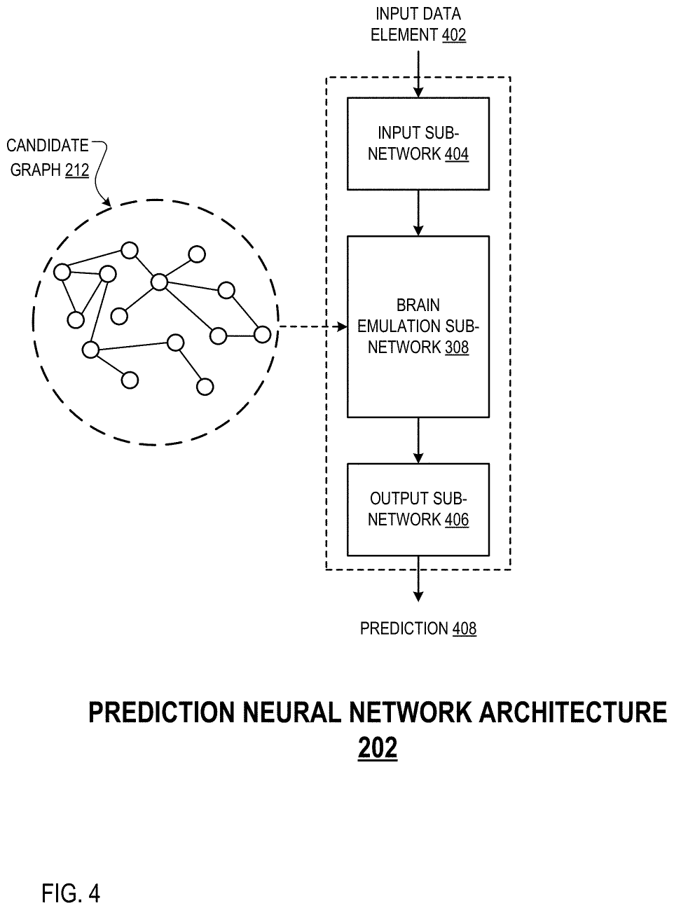

The selection engine 210 uses the auto-encoding performance measures 214 to select the prediction neural network architecture 202 for processing data elements of the specified data type to perform a prediction task, e.g., a classification task, regression task, segmentation task, or any other appropriate prediction task. To select the prediction neural network architecture 202, the selection engine 210 may identify a candidate graph 212 associated with the best (e.g., highest) auto-encoding performance measure, and process the candidate graph 212 to generate the prediction neural network architecture 202. The system 200 may generate a prediction neural network architecture 202 from a candidate graph 212 in a variety of ways. For example, the system 200 may map each node in the candidate graph 212 to a corresponding artificial neuron and each edge in the candidate graph 212 to a connection between a pair of artificial neurons in the prediction neural network architecture 202. Generating a prediction neural network architecture from a candidate graph is described in more detail with reference to FIG. 4.

In some implementations, the system 200 may select multiple prediction neural network architectures 202, e.g., rather than a single prediction neural network architecture 202. For example, the system 200 may identify multiple candidate graphs 212 associated with the best (e.g., highest) auto-encoding performance measures, and process each of these candidate graphs 212 to generate corresponding prediction neural network architectures 202.

The system 200 may be used to construct and maintain a “library” of prediction neural network architectures, where each prediction neural network architecture is predicted to be effective for processing inputs of a respective data type to generate predictions. For example, the library may include one or more prediction neural network architectures that are predicted to be effective for processing image data, one or more prediction neural network architectures that are predicted to be effective for processing audio data, one or more prediction neural network architectures that are predicted to be effective for processing textual data, and so on. A prediction neural network architecture from the library may be provided, e.g., in response to a user request for a prediction neural network architecture for processing inputs of a specified data type.

FIG. 3 shows an example of an auto-encoding neural network architecture 216 that may be generated by the architecture selection system 200 by processing a candidate graph 212 derived from a synaptic connectivity graph representing synaptic connectivity in the brain of a biological organism.

The auto-encoding architecture 216 is configured to process an input data element 302 of a specified data type to generate an output that defines a reconstruction 304 of the input data element 302.

The auto-encoding architecture 216 includes: (i) an input sub-network 306, (ii) a brain emulation sub-network 308, and (iii) an output sub-network 310. As used throughout this specification, a “sub-network” refers to a neural network that is included as part of another, larger neural network.

The input sub-network 306 is configured to process the input data element 302 to generate an embedding of the input data element 302, i.e., a representation of the input data element as an ordered collection of numerical values, e.g., a vector or matrix of numerical values. The input sub-network may have any appropriate neural network architecture that enables it to perform its described function, e.g., a neural network architecture that includes a single fully-connected neural network layer.

The brain emulation sub-network 308 is configured to process the embedding of the input data element (i.e., that is generated by the input sub-network) to generate an alternative representation of the input data element, e.g., as an ordered collection of numerical values, e.g., a vector or matrix of numerical values. The architecture selection system may use the candidate graph 212 derived from the synaptic connectivity graph to specify the neural network architecture of the brain emulation sub-network 308, as will be described in more detail below.

For convenience, throughout this specification, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

The output sub-network 310 is configured to process the alternative representation of the input data element (i.e., that is generated by the brain emulation sub-network 308) to generate the reconstruction 304 of the input data element 302. The output sub-network 310 may have any appropriate neural network architecture that enables it to perform its described function, e.g., a neural network architecture that includes a single fully-connected layer.

During training of the auto-encoding neural network (i.e., having the auto-encoding neural network architecture 216), the parameter values of the input sub-network and the output sub-network are trained, but some or all of the parameter values of the brain emulation sub-network may be static, i.e., not trained. Instead of being trained, the parameter values of the brain emulation sub-network may be determined from the weight values of the edges of the candidate graph 212, as will be described in more detail below. Generally, a brain emulation neural network may have a very large number of trainable parameters and a highly recurrent architecture as a result of being derived from the synaptic connectivity of a biological brain. Therefore training the brain emulation neural network may be computationally-intensive and prone to failure, e.g., as a result of the parameter values of the brain emulation neural network oscillating or diverging rather than converging to fixed values. The auto-encoding neural network may harness the capacity of the brain emulation neural network, e.g., to generate representations that are effective for solving tasks, without requiring the brain emulation neural network to be trained.

The architecture selection system may use the candidate graph 212 derived from the synaptic connectivity graph to specify the neural network architecture of the brain emulation sub-network 308 in any of a variety of ways. For example, the architecture selection system may map each node in the candidate graph 212 to a corresponding: (i) artificial neuron, (ii) artificial neural network layer, or (iii) group of artificial neural network layers in the brain emulation sub-network architecture, as will be described in more detail next.

In one example, the brain emulation sub-network architecture may include: (i) a respective artificial neuron corresponding to each node in the candidate graph 212, and (ii) a respective connection corresponding to each edge in the candidate graph 212. In this example, the candidate graph may be a directed graph, and an edge that points from a first node to a second node in the candidate graph may specify a connection pointing from a corresponding first artificial neuron to a corresponding second artificial neuron in the brain emulation sub-network architecture. The connection pointing from the first artificial neuron to the second artificial neuron may indicate that the output of the first artificial neuron should be provided as an input to the second artificial neuron. Each connection in the brain emulation sub-network architecture may be associated with a weight value, e.g., that is specified by the weight value associated with the corresponding edge in the candidate graph. An artificial neuron may refer to a component of the brain emulation sub-network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(·) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the candidate graph 212 may be an undirected graph, and the architecture selection system 200 may map an edge that connects a first node to a second node in the candidate graph 212 to two connections between a corresponding first artificial neuron and a corresponding second artificial neuron in the brain emulation sub-network architecture. In particular, the architecture selection system 200 may map the edge to: (i) a first connection pointing from the first artificial neuron to the second artificial neuron, and (ii) a second connection pointing from the second artificial neuron to the first artificial neuron.

In another example, the candidate graph 212 may be an undirected graph, and the architecture selection system may map an edge that connects a first node to a second node in the candidate graph 212 to one connection between a corresponding first artificial neuron and a corresponding second artificial neuron in the brain emulation sub-network architecture. The architecture selection system may determine the direction of the connection between the first artificial neuron and the second artificial neuron, e.g., by randomly sampling the direction in accordance with a probability distribution over the set of two possible directions.

In another example, the brain emulation sub-network architecture may include: (i) a respective artificial neural network layer corresponding to each node in the candidate graph 212, and (ii) a respective connection corresponding to each edge in the candidate graph 212. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation sub-network architecture may include a respective convolutional neural network layer corresponding to each node in the candidate graph 212, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge may be specified by the weight value associated with the corresponding edge in the candidate graph), h_{θ}(·) represents the operation of applying one or more convolutional kernels to an input to generate a corresponding output, and σ(·) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture selection system may determine that the brain emulation sub-network architecture includes: (i) a respective group of artificial neural network layers corresponding to each node in the candidate graph 212, and (ii) a respective connection corresponding to each edge in the candidate graph 212. The layers in a group of artificial neural network layers corresponding to a node in the candidate graph 212 may be connected, e.g., as a linear sequence of layers, or in any other appropriate manner.

The auto-encoding neural network architecture 216 is provided for illustrative purposes only, and other auto-encoding neural network architectures based on the candidate graph 212 are possible.

FIG. 4 shows an example of a prediction neural network architecture 202 that may be generated by the architecture selection system 200 by processing a candidate graph 212 derived from a synaptic connectivity graph representing synaptic connectivity in the brain of a biological organism. The architecture selection system 200 may have selected the candidate graph 212 for use in generating the prediction neural network architecture 202, e.g., based on a performance measure of an auto-encoding neural network architecture specified by the candidate graph 212 on an auto-encoding task. Example techniques for selecting the candidate graph 212 to be used in generating the prediction neural network architecture are described in more detail with reference to FIG. 2.

The prediction neural network architecture 202 is configured to process an input data element 402 of the specified data type to generate an output that defines a prediction characterizing the input data element.

In some implementations, the prediction neural network may perform a classification task, e.g., by processing an input data element to generate a classification output that includes a respective score for each class in a set of possible classes. In one example, the input data element may be an image, each possible class may corresponding to a respective category of object (e.g., dog, cat, vehicle, etc.), and the respective score for each class defines a likelihood that the image includes an object of the corresponding object category.

In some implementations, the prediction neural network may perform a regression task, e.g., by processing an input data element to generate a regression output that is drawn from a continuous range of possible output values. In one example, the input data element may be an image depicting an object, and the regression output may define a predicted distance of the object from a camera that captured the image.

In some implementations, the prediction neural network may perform a segmentation task, e.g., by processing an input image to generate a pixel-wise segmentation of the input image. The pixel-wise segmentation of the input image may include, for each pixel of the input image, a respective score for each class in a set of possible classes, where the score for a class defines a likelihood that the pixel is included in the class. The possible classes may include, e.g., person, vehicle, building, or any other appropriate class.

The prediction neural network architecture 202 includes: (i) an input sub-network 404, (ii) a brain emulation sub-network 308, and (iii) an output sub-network 406.

The input sub-network 404 is configured to process the input data element 402 to generate an embedding of the input data element 402, i.e., a representation of the input data element as an ordered collection of numerical values, e.g., a vector or matrix of numerical values. The input sub-network may have any appropriate neural network architecture that enables it to perform its described function, e.g., a neural network architecture that includes a single fully-connected neural network layer.

The brain emulation sub-network 308 is configured to process the embedding of the input data element (i.e., that is generated by the input sub-network) to generate an alternative representation of the input data element, e.g., as an ordered collection of numerical values, e.g., a vector or matrix of numerical values. The architecture selection system may use the candidate graph 212 derived from the synaptic connectivity graph to specify the neural network architecture of the brain emulation sub-network 308, e.g., using the techniques described with reference to FIG. 3.

The output sub-network 406 is configured to process the alternative representation of the input data element (i.e., that is generated by the brain emulation sub-network 308) to generate the prediction 408 corresponding to the input data element 402. The output sub-network 406 may have any appropriate neural network architecture that enables it to perform its described function, e.g., a neural network architecture that includes a single fully-connected layer.

During training of the prediction neural network (i.e., having the prediction neural network architecture 202), the parameter values of the input sub-network and the output sub-network may be trained, but some or all of the parameter values of the brain emulation sub-network may be static, i.e., not trained. Instead of being trained, the parameter values of the brain emulation sub-network may be determined from the weight values of the edges of the candidate graph 212, as described above with reference to FIG. 3.

In some cases, the architecture selection system 200 may generate a prediction neural network architecture 202 from multiple candidate graphs 212 derived from the synaptic connectivity graph, e.g., from a predefined number of candidate graphs 212 associated with the best auto-encoding performance measures. For example, the prediction neural network architecture 202 may include an input sub-network, followed by a linear sequence of multiple brain emulation sub-networks, followed by an output sub-network, where each brain emulation sub-network is specified by a respective candidate graph derived from the synaptic connectivity graph.

The prediction neural network architecture 202 is provided for illustrative purposes only, and other prediction neural network architectures based on the candidate graph(s) 212 are possible.

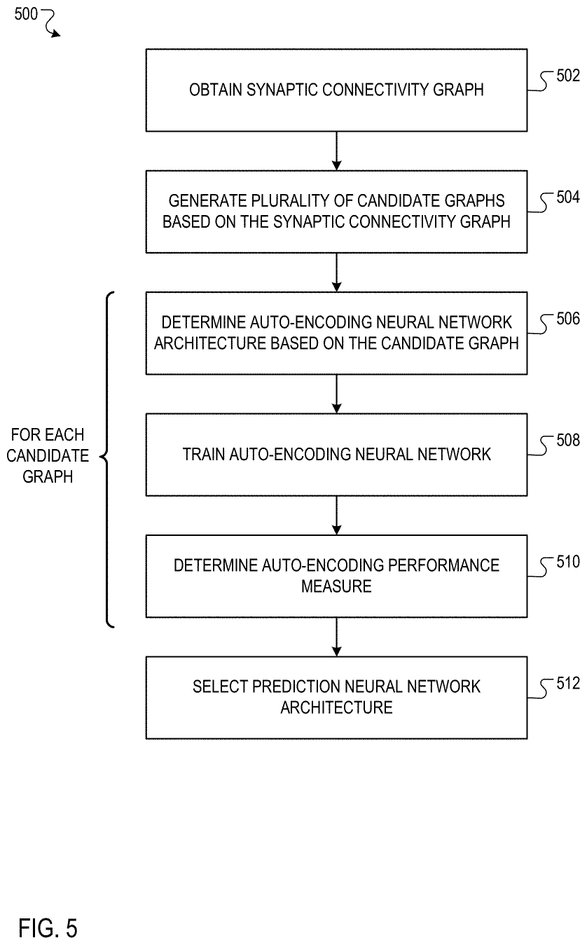

FIG. 5 is a flow diagram of an example process 500 for selecting a neural network architecture for performing a prediction task for data elements of a specified data type. For convenience, the process 500 will be described as being performed by a system of one or more computers located in one or more locations. For example, an architecture selection system, e.g., the architecture selection system 200 of FIG. 1, appropriately programmed in accordance with this specification, can perform the process 500.

The system obtains data defining a synaptic connectivity graph representing synaptic connectivity between neurons in a brain of a biological organism (502).

The system generates multiple candidate graphs based on the synaptic connectivity graph (504).

For each candidate graph, the system determines an auto-encoding neural network architecture based on the candidate graph (506).

For each candidate graph, the system trains an auto-encoding neural network having the auto-encoding neural network architecture based on the candidate graph to perform an auto-encoding task for data elements of a specified data type (508). At each of multiple training iterations, the system processes an input data element of the specified data type using the auto-encoding neural network to generate a reconstruction of the input data element. The system then adjusts the current parameter values of the auto-encoding neural network to reduce an error between: (i) the input data element, and (ii) the reconstruction of the input data element.

For each candidate graph, the system determines a performance measure characterizing a performance of the auto-encoding neural network based on the candidate graph in performing the auto-encoding task for data elements of the specified data type (510).

The system selects a neural network architecture for performing a prediction task for data elements of the specified data type based on the performance measures (512). The prediction task includes processing a data element of the specified data type to generate a corresponding prediction output.

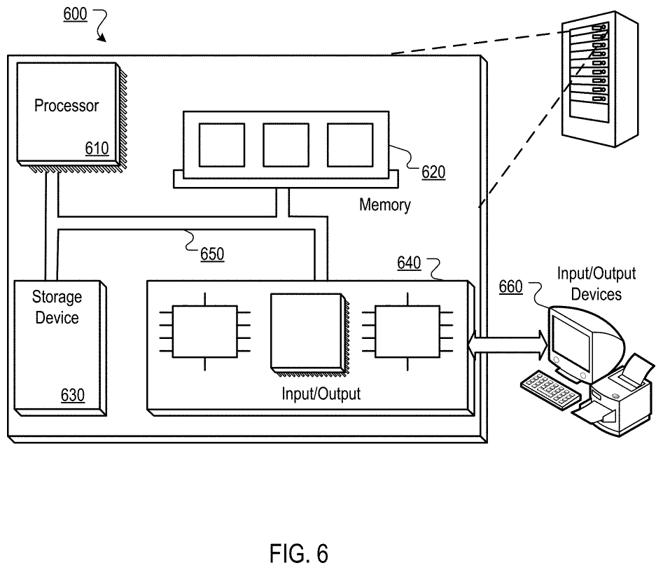

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
obtaining data defining a synaptic connectivity graph representing synaptic connectivity between neurons in a brain of a biological organism;
generating a plurality of candidate graphs based on the synaptic connectivity graph;
for each candidate graph of the plurality of candidate graphs:
determining an auto-encoding neural network architecture based on the candidate graph;
training an auto-encoding neural network having the auto-encoding neural network architecture to perform an auto-encoding task for data elements of a specified data type, comprising, at each of a plurality of training iterations:
processing an input data element of the specified data type using the auto-encoding neural network to generate a reconstruction of the input data element; and
adjusting current parameter values of the auto-encoding neural network to reduce an error between: (i) the input data element, and (ii) the reconstruction of the input data element; and
determining a performance measure characterizing a performance of the auto-encoding neural network in performing the auto-encoding task for data elements of the specified data type; and
selecting a neural network architecture for performing a prediction task for data elements of the specified data type based on the performance measures, wherein the prediction task comprises processing a data element of the specified data type to generate a corresponding prediction output.

2. The method of claim 1, wherein the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.

3. The method of claim 2, wherein obtaining data defining the synaptic connectivity graph representing synaptic connectivity between neurons in the brain of the biological organism comprises:
obtaining a synaptic resolution image of at least a portion of the brain of the biological organism; and
processing the image to identify: (i) a plurality of neurons in the brain, and (ii) a plurality of synaptic connections between pairs of neurons in the brain.

4. The method of claim 3, wherein the synaptic resolution image of the brain of the biological organism is generated using electron microscopy.

5. The method of claim 1, wherein identifying the plurality of candidate graphs based on the synaptic connectivity graph comprises, at each of a plurality of iterations:
processing the synaptic connectivity graph in accordance with current values of a set of graph generation parameters to generate a current candidate graph; and
updating the current values of the set of graph generation parameters based on the performance measure characterizing the performance of the auto-encoding neural network having the auto-encoding neural network architecture corresponding to the current candidate graph in performing the auto-encoding task for data elements of the specified type.

6. The method of claim 5, wherein the current values of the set of graph generation parameters are updated using an optimization technique.

7. The method of claim 6, wherein the optimization technique is a black-box optimization technique.

8. The method of claim 1, wherein the specified data type comprises an image data type, an audio data type, or a textual data type.

9. The method of claim 1, wherein for each candidate graph of the plurality of candidate graphs, the auto-encoding neural network architecture based on the candidate graph comprises a brain emulation sub-network having an architecture that is specified by the candidate graph, wherein:
for each node in the candidate graph, the brain emulation sub-network architecture includes a respective artificial neuron corresponding to the node; and
for each edge in the candidate graph, the brain emulation sub-network architecture includes a connection between a pair of artificial neurons that correspond to a pair of nodes in the candidate graph that are connected by the edge.

10. The method of claim 9, wherein the auto-encoding neural network architecture based on the candidate graph further comprises an input sub-network and an output sub-network, wherein processing the input data element of the specified data type using the auto-encoding neural network having the auto-encoding neural network architecture comprises:
processing the input data element by the input sub-network to generate an embedding of the input data element;
processing the embedding of the input data element by the brain emulation sub-network to generate an alternative representation of the input data element; and
processing the alternative representation of the input data element by the output sub-network to generate the reconstruction of the input data element.

11. The method of claim 10, wherein adjusting the current parameter values of the auto-encoding neural network comprises:
adjusting only current parameter values of the input sub-network and the output sub-network,
wherein parameter values of the brain emulation sub-network are not adjusted during the training.

12. The method of claim 11, wherein the parameter values of the brain emulation sub-network are determined prior to the training based on weight values associated with synaptic connections between neurons in the brain of the biological organism.

13. The method of claim 1, wherein determining the performance measure characterizing the performance of the auto-encoding neural network in performing the auto-encoding task for data elements of the specified data type comprises, after the training of the auto-encoding neural network:
processing each of one or more validation data elements of the specified data type using the auto-encoding neural network to generate a respective reconstruction of each validation data element; and
determining the performance measure based on, for each validation data element, an error between: (i) the validation data element, and (ii) the reconstruction of the validation data element.

14. The method of claim 1, wherein the auto-encoding neural network is trained for a predefined number of training iterations.

15. The method of claim 1, wherein the prediction task is different than the auto-encoding task.

16. The method of claim 1, wherein the prediction task comprises processing a data element of the specified data type to generate a classification of the data element into a plurality of classes.

17. The method of claim 1, wherein selecting the neural network architecture for performing the prediction task for data elements of the specified type based on the performance measures comprises:
selecting a candidate graph of the plurality of candidate graphs based on the performance measures; and
determining a prediction neural network architecture based on the candidate graph.

18. A system comprising:
one or more computers; and
one or more storage devices communicatively coupled to the one or more computers, wherein the one or more storage devices store instructions that, when executed by the one or more computers, cause the one or more computers to perform operations comprising:
obtaining data defining a synaptic connectivity graph representing synaptic connectivity between neurons in a brain of a biological organism;
generating a plurality of candidate graphs based on the synaptic connectivity graph;
for each candidate graph of the plurality of candidate graphs:
determining an auto-encoding neural network architecture based on the candidate graph;
training an auto-encoding neural network having the auto-encoding neural network architecture to perform an auto-encoding task for data elements of a specified data type, comprising, at each of a plurality of training iterations:
processing an input data element of the specified data type using the auto-encoding neural network to generate a reconstruction of the input data element; and
adjusting current parameter values of the auto-encoding neural network to reduce an error between: (i) the input data element, and (ii) the reconstruction of the input data element; and
determining a performance measure characterizing a performance of the auto-encoding neural network in performing the auto-encoding task for data elements of the specified data type; and
selecting a neural network architecture for performing a prediction task for data elements of the specified data type based on the performance measures, wherein the prediction task comprises processing a data element of the specified data type to generate a corresponding prediction output.

19. One or more non-transitory computer storage media storing instructions that when executed by one or more computers cause the one or more computers to perform operations comprising:
obtaining data defining a synaptic connectivity graph representing synaptic connectivity between neurons in a brain of a biological organism;
generating a plurality of candidate graphs based on the synaptic connectivity graph;
for each candidate graph of the plurality of candidate graphs:
determining an auto-encoding neural network architecture based on the candidate graph;
training an auto-encoding neural network having the auto-encoding neural network architecture to perform an auto-encoding task for data elements of a specified data type, comprising, at each of a plurality of training iterations:
processing an input data element of the specified data type using the auto-encoding neural network to generate a reconstruction of the input data element; and
adjusting current parameter values of the auto-encoding neural network to reduce an error between: (i) the input data element, and (ii) the reconstruction of the input data element; and
determining a performance measure characterizing a performance of the auto-encoding neural network in performing the auto-encoding task for data elements of the specified data type; and
selecting a neural network architecture for performing a prediction task for data elements of the specified data type based on the performance measures, wherein the prediction task comprises processing a data element of the specified data type to generate a corresponding prediction output.

20. The non-transitory computer storage media of claim 19, wherein the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism.
